(19) United States
(12) Patent Application Publication
(10) Pub. No.: US 2002/0021132 A1
(43) Pub. Date: Feb. 21, 2002

(54) Continuity tester for long wires

(76) Inventor: Roger D. Halden, Columbia Falls, MT (US)

Correspondence Address: Richard C. Conover, Suite 404, 104 East Main Street, P. O. Box 1329, Bozeman, MT, 59771-1329, US

(21) Appl. No.: 09/886,948

(22) Filed: Jun. 21, 2001

Related U.S. Application Data
(60) Provisional application No. 60/213,077, filed on Jun. 21, 2000.

(51) Int. Cl. H01H 31/02

(52) U.S. Cl. 324/556

(57) ABSTRACT

A continuity tester for testing continuity of long electrical lines having two units with one unit located at each end of the line to be tested. A battery is provided with each unit. A ground lead is provided with each unit for connecting the battery through a buzzer to ground. Further, a probe lead is provided for connecting the battery to one end of the line to be tested. The first unit uses the battery with one polarity and the second unit uses the battery with a reversed polarity.

### BACKGROUND OF INVENTION

This invention relates to a continuity tester for testing the continuity of long electrical lines, such as telephone cable pairs.

Testing continuity of wires at a telephone switching center can be very complicated and time consuming because of the large number of wires involved. A typical switching center for a telephone system includes banks of wiring blocks located at a Main Distribution Frame (“MDF”). Each of the wiring blocks may have a 100-cable pairs or more.

A cable pair is commonly used in telephone systems for electrically connecting a customer's telephone with the switching center of the telephone company. Each of these pairs includes a “ring” lead and a “tip” lead.

At the MDF, both the “ring” lead and “tip” lead of the cable pair have pins which are exposed in the wiring block. From the MDF, the cable pairs are run to other equipment commonly located on other floors in the switching center building. For example, the wire pairs may be run to and terminate at a Digital Subscriber Cross-Connect (“DSX”). In the DSX equipment, the cable pairs, from the MDF, terminate in panels, such as a 64-pair panel. At the panel, each “ring” lead and “tip” lead have pins which are exposed in the panel. At the DSX location, there may be several panels collectively having thousands of wires connecting the MDF with the DSX. Checking continuity and reversal of the “ring” and “tip” leads at these locations is very difficult and time consuming.

Today, the known way of testing for continuity of cable pairs between the MDF and DSX is to have a person string an electrical wire from the MDF location to the DSX location. This wire is connected to one pin of a cable pair. Another person at the MDF location takes a voltmeter with a continuity tester and connects a ground lead to the wire running to the DSX location and takes the other lead and connects it to the appropriate pin to be tested. If the line is continuous, the voltmeter indicates this. The MDF person must then telephone the person at the DSX location to move the wire to another pin. The process is very time consuming.

What is needed is a simple continuity tester device where one person can take one unit to the MDF location, the other person can take another unit to the DSX location, and when the two units are connected to the line to be tested, there is an immediate indication for both persons whether the line has no short, or whether the “ring” and “tip” lines of a cable pair have been reversed at the DSX location.

### SUMMARY OF INVENTION

A continuity tester for testing continuity of long electrical lines having two units with one unit located at each end of the line to be tested. A battery is provided with each unit. A ground lead is provided with each unit for connecting the battery through a buzzer to ground. Further, a probe lead is provided for connecting the battery to one end of the line to be tested. The first unit uses the battery with one polarity and the second unit uses the battery with a reversed polarity.

### DESCRIPTION OF THE DRAWINGS

In order that the invention may be clearly understood and readily carried into effect, a preferred embodiment of the invention will now be described, by way of example only, with reference to the accompanying drawings wherein:

FIG. 1 is an electrical schematic of the electrical circuit used with one unit of the present invention;

FIG. 2 is a partially exploded front elevational view of the present invention;

FIG. 3 is a partially exploded left side elevational view of the present invention shown in FIG. 2;

FIG. 4 is a top plan view of the present invention shown in FIG. 2;

FIG. 5 is a bottom plan view of the present invention shown in FIG. 2;

FIG. 6 is an electrical schematic of the present invention used to test continuity of a cable pair; and

FIG. 7 is an electrical schematic of a second embodiment of the present invention used to test a cable pair.

### DESCRIPTION OF PREFERRED EMBODIMENTS

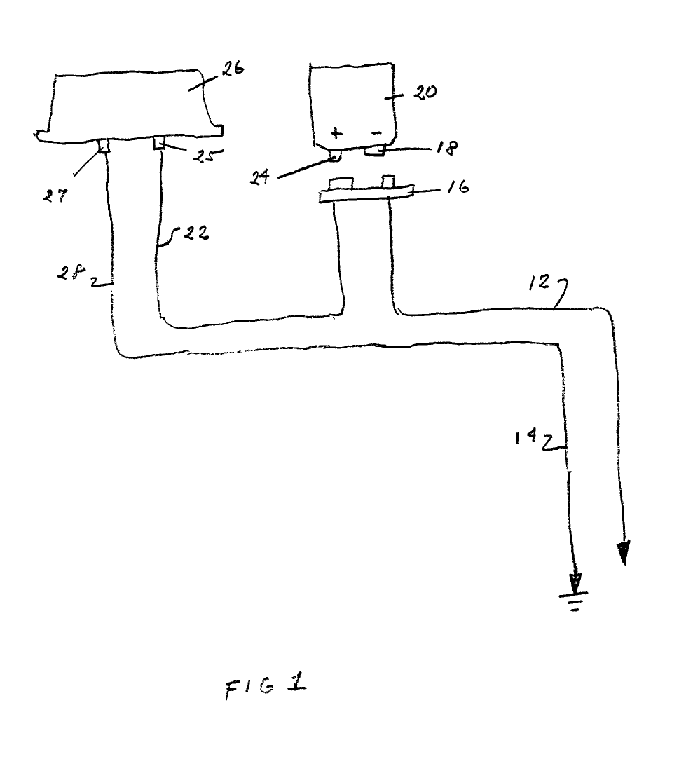

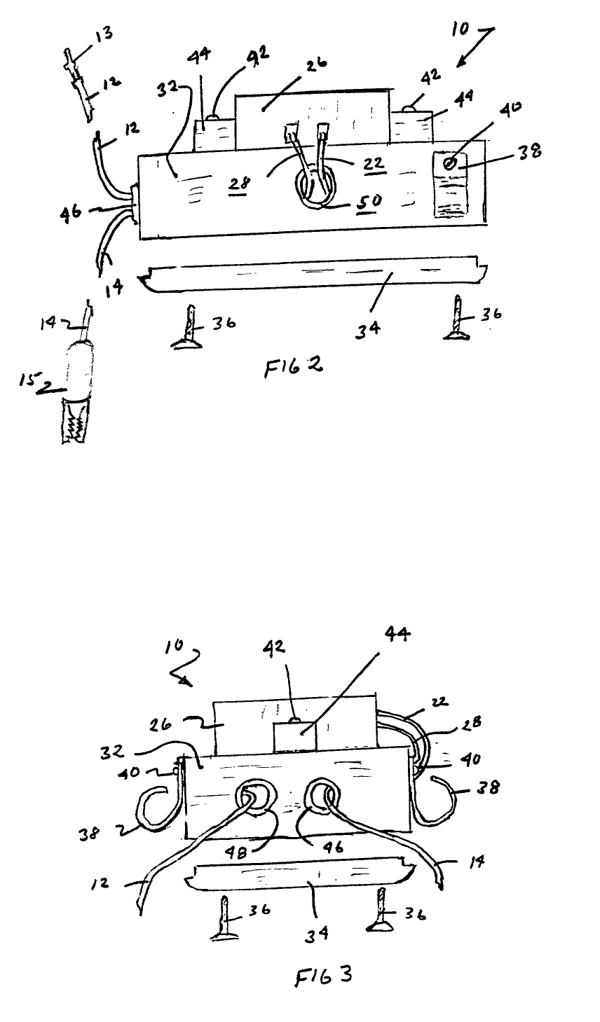

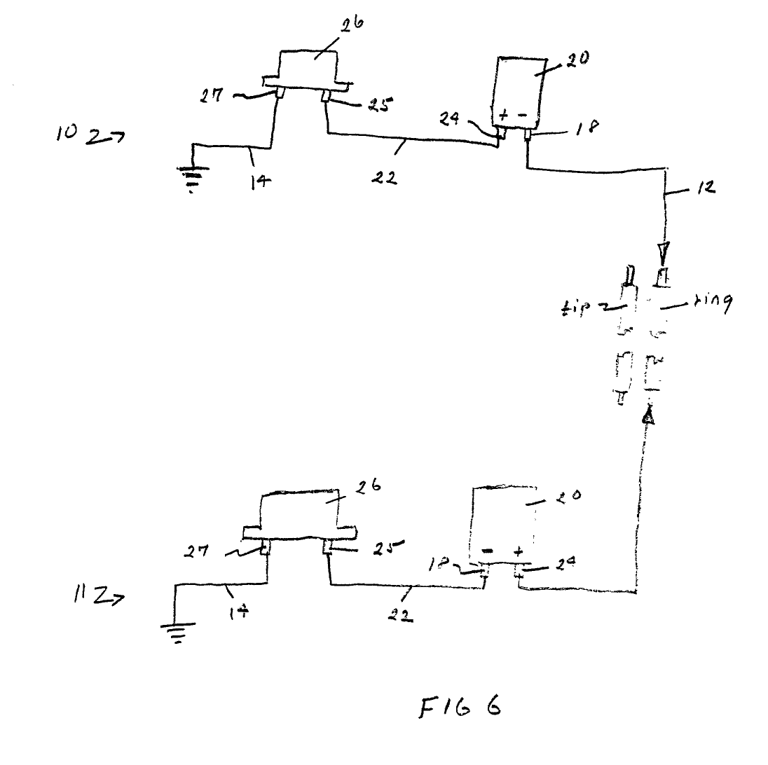

A continuity tester 10 is shown in FIGS. 2-5. A pair of continuity testers 10 and 11 are used together to test the continuity of a long electrical line. The continuity tester 10 is shown schematically in FIG. 1. There is no separate schematic for tester 11, but the only difference between the two continuity testers 10 and 11 is that the battery polarity is reversed between the two.

As shown in FIG. 1, the continuity tester 10 includes a lead 12 having a probe end 13 (shown in FIG. 2) to be electrically connected to the wire to be tested, and a ground lead 14 to be electrically connected to a common ground which may include an earth ground. As shown in FIG. 2, lead 14 may have an alligator clip end 15 for connecting lead 14 to ground.

The lead 12 is connected through a battery connector 16 to the negative terminal 18 of battery 20. In a preferred embodiment, the battery 20 is a conventional 9-volt battery, and the connector 16 is a conventional 9-volt battery connector. A lead 22 is connected through battery connector 16 to the positive terminal 24 of battery 20. The other end of lead 22 is connected to a first terminal 25 of a conventional DC electrical buzzer 26. The ground lead 14 connects a second terminal 27 of buzzer 26 to ground.

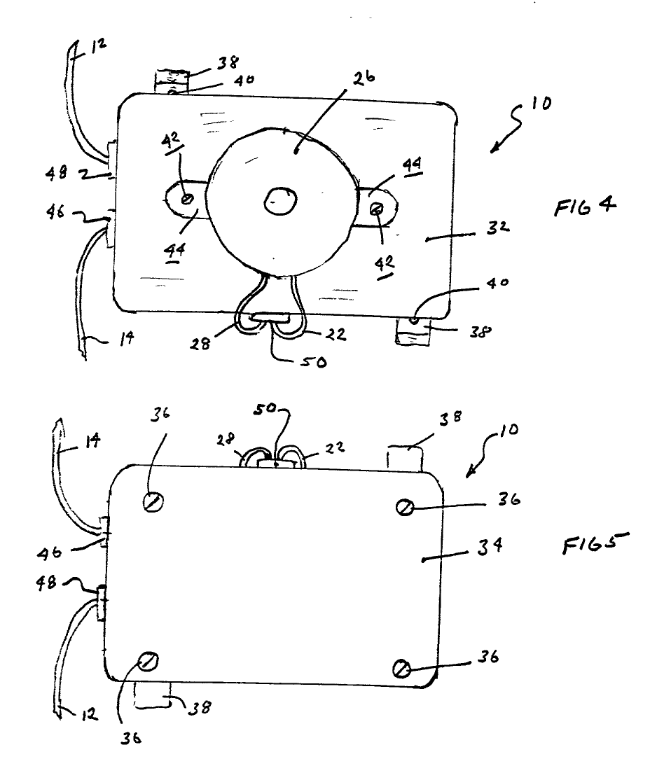

As shown in FIG. 3, the battery 20 is held inside a housing 30, as shown in FIGS. 2-5. Housing 30 includes an open top box case 32 which is covered with cover 34. Cover 34 is secured to box housing 32 with screws 36 which extend through bores (not shown) in cover 34 and received by screw receiving posts (not shown) mounted in box housing 32. A pair of cord storage clips 38 are secured to box housing 32 with screws 40. The buzzer 26 includes a pair of bosses 44, each of which are integrally formed on opposite sides of buzzer 26. Buzzer 26 is secured to a bottom wall of housing 32 with screws 42 extending through bores (not shown) in bosses 44.

Wire 14 extends into the interior of box case 32 through a grommet 46. Similarly, wire 12 extends into the interior of box case 32 through a grommet 48. Wires 28 and 22 extend into interior of box case 32 through a grommet 50.

The continuity tester 11 is identical to the electrical schematic of continuity tester 10, shown in FIG. 1, except that the battery polarities are reversed. That is, lead 12 is connected to the positive terminal of battery 20, and lead 22 is connected to the negative terminal of battery 20.

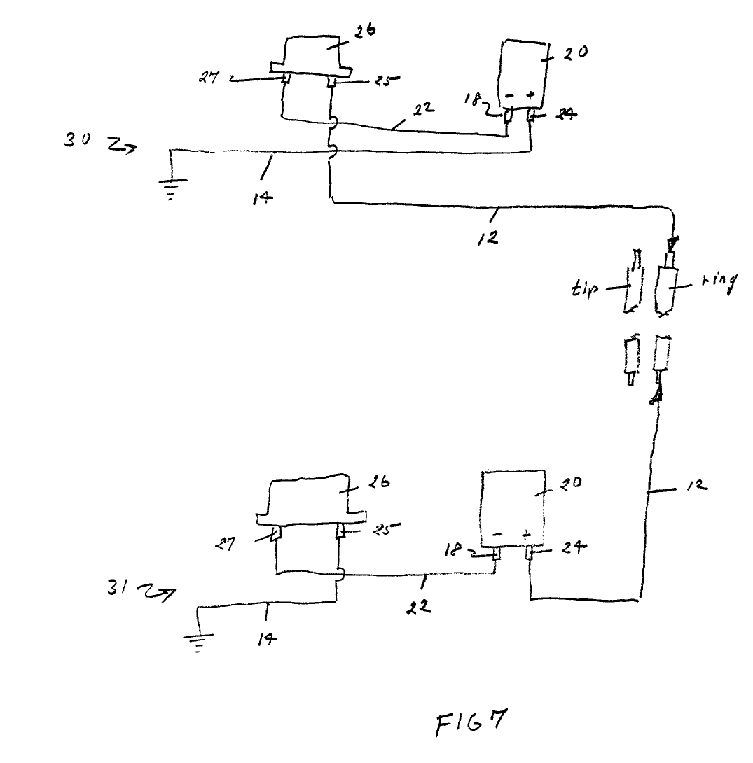

In using the present invention, a description will follow when using continuity testers 10 and 11 in testing a cable pair used in telephony. In this example, the cable pair to be tested has a terminal end located at a Main Distribution Frame (“MDF”) and the other terminal end located at a Digital Subscriber Cross-Connect (“DSX”). The DSX equipment is located several floors above the MDF equipment in a typical telephone switching center building. In this example, continuity tester 10 may be used at the MDF equipment location. Here, the alligator clip 15 is connected to a ground bus located at the MDF. The probe 13 is then electrically connected with one of the wires of the cable pair, such as the “ring” pin, by contacting probe 13 with the “ring” pin. This illustration is shown in FIG. 6.

A second user takes continuity tester 11 to the DSX location and connects the alligator clip 15 to a ground bus located with the DSX equipment. The probe 13 is then electrically connected to the “ring” pin exposed at the DSX equipment by contacting the pin with probe 13. If there is no short in the “ring” wire of the cable pair, both buzzers 26 will sound. On the other hand, if there is a short in the “ring” wire, neither buzzer will sound. One other common problem is that when the cable pair is mounted in the DSX, for example, the “ring” and “tip” wires are reversed. If this were to occur, then the continuity tester 10 would be connected to the “ring” wire and continuity tester 11 would be connected to the “tip” wire. In this situation as well, neither buzzer would sound. It is recognized that when the alligator clip 15 of both units 10 and 11 have been connected to ground, all of the wires in the cable pair panel to be tested can be tested for continuity and/or wire reversal in a quick and easy manner.

This equipment can also be used to test cable pairs by determining one common wire between the MDF equipment and the DSX equipment, such as a “ring” lead of the cable pair. In this situation, the alligator clip 15 of both units 10 and 11 are clipped to this “ring” lead rather than to earth ground. All other wires in the panel can be tested for continuity or reversal as described above.

A second embodiment of the present invention is shown schematically in FIG. 7. Again, the continuity tester is comprised of two units, a first unit 30 and a second unit 31. The same elements as in the first embodiment are shown with identical numbers. The connections of the various leads are different, however, and they are described below.

With regard to the first unit 30, the ground lead 14 is connected between ground and the positive terminal 24 of battery 20. The negative terminal 18 of battery 20 is connected to the second terminal 27 of buzzer 26. The first terminal 25 of buzzer 26 is connected to the probe lead 12.

With regard to the second unit 31, the ground lead 14 is connected to the first terminal 25 of buzzer 26. The second terminal 27 of buzzer 26 is connected via lead 22 to the negative terminal 18 in battery 20. The positive terminal 24 of battery 20 is connected to the probe lead 12.

The second embodiment operates in a manner similar to the first embodiment.

While the fundamental novel features of the invention have been shown and described, it should be understood that various substitutions, modifications and variations may be made by those skilled in the art without departing from the spirit or scope of the invention. Accordingly, all such modifications or variations are included in the scope of the invention as defined by the following claims:

I claim:

1. A continuity tester for testing long electrical lines comprising:
a first unit comprising:
a battery having a positive terminal and a negative terminal;
an electrically actuated indicator having a first terminal and a second terminal;
a ground lead having one end for connecting to a common ground, and a second end connected to a second terminal of the indicator;
a lead connecting the first terminal of the indicator to the positive terminal of the battery; and
a probe lead for connecting the negative terminal of the battery to one end of the electrical line to be tested;
a second unit comprising:
a battery with a positive terminal and a negative terminal;
an electrically actuated indicator having a first terminal and a second terminal;
a ground lead having one end for connecting to a common ground, and a second end connected to a second terminal of the indicator;
a lead connecting the first terminal of the indicator to the negative terminal of the battery; and
a probe lead for connecting the positive terminal of the battery to one end of the electrical line to be tested; and
whereby both indicators will indicate whether the electrical line is continuous when the first unit is connected to one end of the electrical line and the second end is connected to the second end of the electrical line.

2. A continuity tester according to claim 1 wherein each indicator is a buzzer.

3. The continuity tester according to claim 1 wherein each ground lead includes an alligator clip for connecting the ground lead to ground.

4. The continuity tester according to claim 1 wherein the common ground comprises an earth ground.

5. A continuity tester for testing long electrical lines comprising:
a first unit comprising:
a battery with a positive terminal and a negative terminal;
an electrically actuated indicator having a first terminal and a second terminal;
a ground lead having one end for connecting to a common ground, and a second end connected to the positive terminal of the battery;
a lead connecting the second terminal of the indicator to the negative terminal of the battery; and
a probe lead for connecting the first terminal of the indicator to one end of the electrical line to be tested;
a second unit comprising:
a battery with a positive terminal and a negative terminal;
an electrically actuated indicator having a first terminal and a second terminal;
a ground lead having one end for connecting to a common ground, and a second end connected to the first terminal of the indicator;
a lead connecting the second terminal of the indicator to the negative terminal of the battery; and
a probe lead for connecting the positive terminal of the battery to the second end of the line to be tested; and
whereby both indicators will indicate whether the electrical line is continuous when the first unit is connected to one end of the electrical line and the second end is connected to the second end of the electrical line.

6. A continuity tester according to claim 5 wherein each indicator comprises a buzzer.

7. The continuity tester according to claim 5 wherein each ground lead includes an alligator clip for connecting the ground lead to ground.

8. The continuity tester according to claim 5 wherein the common ground comprises an earth ground.
